(19) United States
(12) Patent Application Publication
(10) Pub. No.: US 2008/0034970 A1
(43) Pub. Date: Feb. 14, 2008

(54) Sulfur hexafluoride recycling system and method for recycling sulfur hexafluoride

(76) Inventors: Frank Jansen, San Jose, CA (US); Walter Whitlock, Chapel Hill, NC (US)

Correspondence Address: THE BOC GROUP, INC., 575 MOUNTAIN AVENUE, MURRAY HILL, NJ, 07974-2064, US

(21) Appl. No.: 11/502,023

(22) Filed: Aug. 10, 2006

(51) Int. Cl. B01D 53/14

(52) U.S. Cl. 95/233; 95/235

(57) ABSTRACT

The present invention relates to a system and method for the recycling of sulfur hexafluoride (SF₆), from a waste gas of a manufacturing process, such as a semiconductor processing method. In particular, the present invention provides a simplified system and method that utilizes additional SF₆ as a purge gas for the system pump and allows relatively easy separation of the SF₆ from the other waste gas components.

### FIELD OF THE INVENTION

The present invention relates to a system and method for recycling sulfur hexafluoride (SF₆). In particular, the present invention relates to a system and method for recycling SF₆ used in a semiconductor processing method, such as a chamber cleaning process.

### BACKGROUND OF THE INVENTION

Many manufacturing processes using gases produce exhaust streams that may contain recyclable components. Many of these gases are expensive and therefore if recycled could significantly reduce production costs. In addition, the exhaust gases often contain components that are toxic, reactive or difficult to handle. This is especially true for the manufacture of semiconductor devices that employ expensive and dangerous gases in the production processes.

For example, semiconductor manufacturing processes often use or produce SF₆, that has a very high global warming potential, and that if recycled would present no environmental concern and would also reduce overall costs related to the abatement or disposal thereof.

Most process gases, including SF₆, from semiconductor processes are not recycled. Rather, the process gases are disposed of after use in the process chamber. As noted above, these gases may be expensive and may have dangerous properties. In addition, it is common for a relatively large excess of process gases to be used in the production step and therefore a high percentage of the process gases are not consumed during the production step. This results in a greater expense and risk. Recycling just the unused process gases could provide a significant cost reduction for the process.

For example, FIG. 1 is a schematic diagram of a semiconductor processing system according to the prior art utilizing SF₆ as a process gas. In particular, the system of FIG. 1 includes a source of SF₆ 10, a source of O₂ 20, a plasma chamber 30, a pump 40, and waste treatment facility 50. SF₆ and O₂ may be provided to the plasma chamber 30, such as a PECVD tool, used to deposit flat panel display components, solar cells or the like. The pump 40 draws gas through the plasma chamber 30, and the gas exits the system to waste treatment 50. For the purpose of removing extraneous deposited materials from the chamber, the mixture of SF₆ and O₂ is provided in about a 10:1 ratio and the mixture is activated in a plasma to start the process within the plasma chamber 30. However, studies have shown that SF₆ utilization is extremely poor, and that more than 75% of the SF₆ exits from the plasma chamber 30, and pump 40, unreacted. For such an operation, the composition of the gas leaving the pump 40, is typically made up of greater than 75% SF₆; SiF₄ from the reaction of Si, SiOₓ and SiNₓ with F—; HF from the reaction of :H in SiOₓ (10 at %) and SiNₓ (25 at %) with HF; SO₂ and SO₃ from the reaction of O₂ precursor with sulfur from decomposed SF₆; some unreacted F₂; and pump purge gas, such as N₂.

The recycle of SF₆ is desirable, from both an environmental and cost savings perspective. There have been various SF₆ recycle schemes proposed. For example, sulfur can be added to the system to react with the exhaust gases (e.g., SiF₄, HF, F₂, SO₂, SO₃, SOF₂, SO₂F₂, etc.) and be converted to SF₆. However, these systems are relatively complex, and require the use of large amounts of sulfur at temperatures greater than 500° C.

There remains a need in the art for improvements to the recycle of SF₆.

### SUMMARY OF INVENTION

The present invention provides a simplified method and system for the recycle of SF₆, particularly from a semiconductor processing method.

### BRIEF DESCRIPTION OF DRAWINGS

FIG. 1 is a schematic drawing of a prior art semiconductor processing system

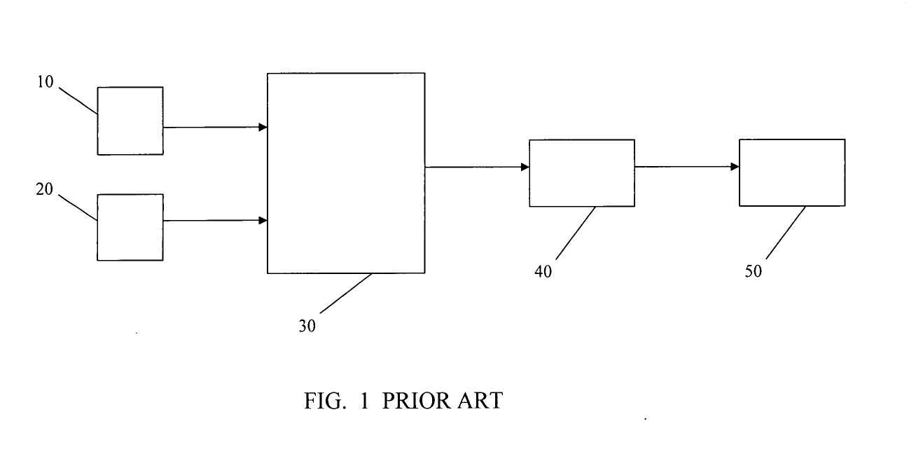

FIG. 2 is a schematic drawing of a system according to one embodiment of the present invention.

### DETAILED DESCRIPTION OF THE INVENTION

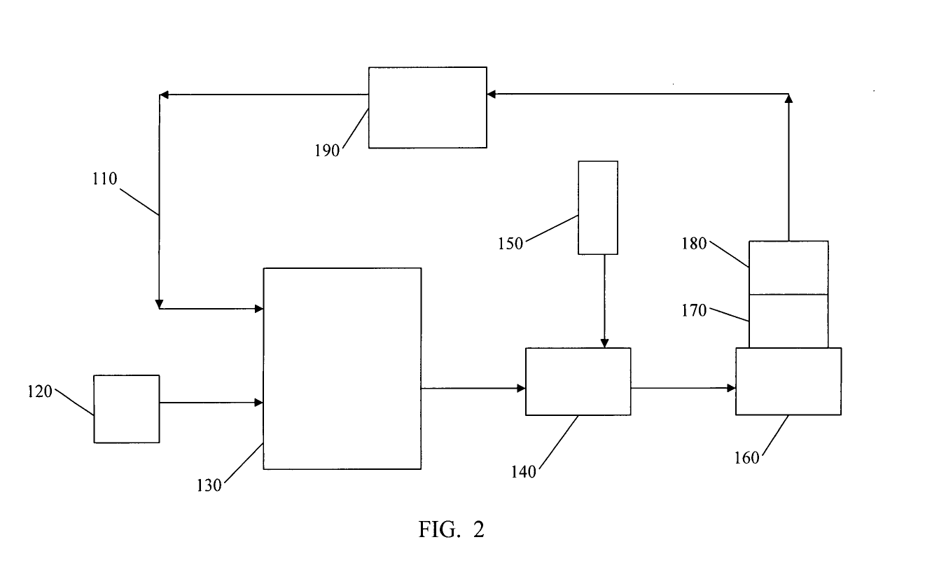

The present invention provides a simplified method and system for the recycle of SF₆, particularly from a semiconductor processing method. In particular, FIG. 2 is a schematic drawing showing a system according to the present invention, wherein a source of recycled SF₆ 110, and a source of O₂ 120, provide a mixture of gas to a plasma chamber 130. A source of fresh SF₆ 150, is provided to introduce SF₆ at the purge inlet of the process pump 140, and therefore eliminate the need for a separate purge gas, such as N₂. The amount of SF₆ from SF₆ source 150, is up to 100% of the amount of recycled SF₆ provided from recycled SF₆ source 110, used during the process. Preferable, the amount of fresh SF₆ is from 3 standard liters per minute (slm) to 50 slm. Most commercial pumps can easily handle the added flow rate that may be more than 50 slm through the purge. However, the pump 140, should be chosen to meet this criteria. Preferably the pump 140, is a dry pump, but other types, such as oil pumps can be used.

As noted above, up to 25% of the recycled SF₆ 110 will typically react with materials such as silicon or silicon-based insulators deposited in chamber 130. In a process where cleaning gases are recycled, the gas that does react needs to be replenished. In particular, the total flow rate of SF₆ gas into the plasma chamber 130 must be regulated to be relatively constant. In the present invention, this is accomplished by the regulation of the SF₆ gas flow rate from the fresh SF₆ source 150 into the purge inlet of the pump 140. For example, a mass flow controller can measure the flow rate of the fresh SF₆ and provide a representative signal to an electronic control system.

In order to provide a purified stream of SF₆, as shown in FIG. 2, the gas exiting the pump 140, is sent through a caustic wet scrubber 160, and is scrubbed to remove SiF₄, HF, sulfur oxides and other gaseous compounds resulting from the plasma reaction between SF₆ and the chamber deposits. The remaining gas is then demisted in a demister 170, and dried in a dryer 180, to produce an SF₆ stream that can be recycled. The method and system of the present invention produces an SF₆ recycle stream having a purity greater than 99.9% that is sufficient for reuse as a semiconductor processing gas.

Optionally, a gas accumulator 190, may be included in the recycle line to serve as a gas buffer. Such an accumulator may be necessary to form a buffer between the instantaneous demand and the instantaneous supply of the SF₆ gas. For example, one simple form of an accumulator is a tank that may be pressurized by the vacuum pump or an auxiliary compressor.

The present invention is particularly useful for etching processes, such as chamber cleaning, FPD etch, MEMS etching processes and Si wafer thinning, among others. The present invention provides several advantages over systems and methods known in the prior art. In particular, by providing a system and method that allows for simplified recycle of SF₆, a significant amount of waste can be eliminated. As noted above, this is beneficial from both an environmental and an economic perspective.

It is anticipated that other embodiments and variations of the present invention will become readily apparent to the skilled artisan in the light of the foregoing description and it is intended that such embodiments and variations likewise be included within the scope of the invention as set out in the appended claims.

What is claimed:

1. A method for the recovering SF₆ from a waste gas stream of a manufacturing system, comprising:
drawing the waste gas stream from a process chamber of the manufacturing system;
wet scrubbing the waste gas stream to remove non SF₆ gas components and to produce a scrubbed gas stream;
removing water vapor from the scrubbed gas stream to produce a dry gas stream of SF₆.

2. A method according to claim 1, wherein drawing the waste gas stream comprises drawing with a pump.

3. A method according to claim 2, wherein the pump is a vacuum pump.

4. A method according to claim 2, wherein the pump is a dry vacuum pump.

5. A method according to claim 2, wherein the dry gas stream is recycled to the process chamber of the manufacturing system.

6. A method according to claim 5, wherein make up SF₆ is added to the dry gas stream prior to recycling to the process chamber.

7. A method according to claim 6, wherein the make up SF₆ is added to a recycle loop for the dry gas steam.

8. A method according to claim 6, wherein the make up SF₆ is added as the purge gas to the pump.

9. A method according to claim 6, further comprising controlling the flow rate of SF₆ to the process chamber to maintain a constant flow rate.

10. A method according to claim 1, wherein the manufacturing system is a semiconductor manufacturing system.

11. A method according to claim 10, wherein the process chamber is a plasma chamber.

12. A method for the recovering SF₆ from a waste gas stream of a manufacturing system, comprising:
drawing the waste gas stream from a process chamber of the manufacturing system using a pump;
providing SF₆ gas to the purge side of the pump to produce of mixture of SF₆ gas and waste gas;
wet scrubbing the mixture to remove non SF₆ gas components and to produce a scrubbed mixture;
removing water vapor from the scrubbed mixture to produce a dry gas stream of SF₆.

13. A method according to claim 12, wherein the non SF₆ gas components include SF₄, HF and sulfur oxides.

14. A method according to claim 12, wherein removing water vapor comprises demisting the mixture and drying the mixture.

15. A method according to claim 12, wherein the dry gas stream is recycled to the process chamber of the manufacturing system.

16. A method according to claim 12, wherein providing SF₆ gas comprises providing an amount of SF₆ equal to the amount of SF₆ expended in the process chamber.

17. A method according to claim 1, further comprising accumulating the dry gas stream.

18. A manufacturing system comprising:
a process chamber having at least one inlet and at least one outlet;
a source of recycled SF₆ gas communicating with the at least one inlet of the process chamber;
a pump having an inlet communicating with the at least one outlet of the process chamber, a purge gas inlet and an outlet;
a source of fresh SF₆ gas communicating with the purge gas inlet of the pump;
a scrubber communicating with the outlet the pump;
drying means communicating with the scrubber and with the source of recycled SF₆ gas.

19. A system according to claim 18, wherein the scrubber is a caustic wet scrubber.

20. A system according to claim 18, wherein the manufacturing system is a semiconductor processing system.

21. A system according to claim 18, wherein the process chamber is a plasma chamber.

22. A system according to claim 18, wherein the pump is a vacuum pump.

23. A system according to claim 18, wherein the pump is a dry vacuum pump.

24. A system according to claim 18, wherein the source of recycled SF₆ gas comprises an accumulator.

25. A system according to claim 24, wherein the accumulator is a buffer tank.

26. A system according to claim 18, wherein the drying means comprises a demister and a dryer.

27. A system according to claim 18, further comprising control means to maintain a constant flow rate of SF₆ gas to the process chamber.
